(19) United States
(12) Patent Application Publication
(10) Pub. No.: US 2006/0056189 A1
(43) Pub. Date: Mar. 16, 2006

(54) Collapsible lampshade frame

(76) Inventor: Sen-Yong Lin, Taipei Hsien (TW)

Correspondence Address: HERSHKOVITZ & ASSOCIATES, 1725 I STREET NW, SUITE 300, WASHINGTON, DC, 20006, US

(21) Appl. No.: 10/939,507

(22) Filed: Sep. 14, 2004

(51) Int. Cl. F21V 19/00

(52) U.S. Cl. 362/382

(57) ABSTRACT

A collapsible lampshade frame has an upper ring, a lower ring and multiple ribs. The upper ring has a central mounting bracket, multiple radial supports and an outer ring. Each radial support has a bottom and multiple wavy recesses. The wavy recesses are formed on the bottom of the radial supports. Each rib has a distal end and a fork. The fork is formed in the distal end and engages the wavy recesses on the radial supports. When the forks are disengaged from the wavy recesses, the ribs can be pivoted so the frame occupies a small volume.

### BACKGROUND OF THE INVENTION

1. Field of the Invention

The present invention relates to a lampshade frame, especially to a collapsible lampshade frame.

2. Description of the Prior Arts

Most lamps such as table lamps or floor lamps usually comprise a stand or body, a bulb and a lampshade. The lampshade is mounted on the stand or body and is mounted around the bulb to keep the bulb from being inadvertently touched and to soften or direct the light from the bulb. The conventional lampshade comprises a shade and a frame. The frame is mounted on the stand or body. The shade is mounted on the frame. When the lamp is moved or stored, the bulb, the stand or body and the lampshade can be moved separately. However, the frame is a single unit and cannot be taken apart and reassembled easily. Therefore when the lamp is moved or stored, the frame will occupy too much space.

To overcome the shortcoming, the present invention provides a collapsible lampshade frame to mitigate or obviate the aforementioned problems.

### SUMMARY OF THE INVENTION

The main objective of the present invention is to provide a collapsible lampshade frame. A collapsible lampshade frame in accordance with the present invention comprises an upper ring, a lower ring and multiple ribs. The upper ring has a central mounting bracket, multiple radial supports and an outer ring. Each radial support has a bottom and multiple wavy recesses. The wavy recesses are formed on the bottom of the radial supports. Each rib has a distal end and a fork. The fork is formed in the distal end and engages the wavy recesses on the radial supports. When the forks are disengaged from the wavy recesses, the ribs can be pivoted on the lower ring so the frame occupies a small volume.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a collapsible lampshade frame in accordance with the present invention;

FIG. 2 is an exploded perspective view of the collapsible lampshade frame in FIG. 1;

FIG. 3 is a side view in partial section of the collapsible lampshade frame in FIG. 1 with an upper ring, a rib and a radial support;

FIG. 4 a perspective view of the collapsible lampshade frame in FIG. 1 when the ribs are collapsed.

### DETAILED DESCRIPTION OF THE PREFERRED EMBODIMENTS

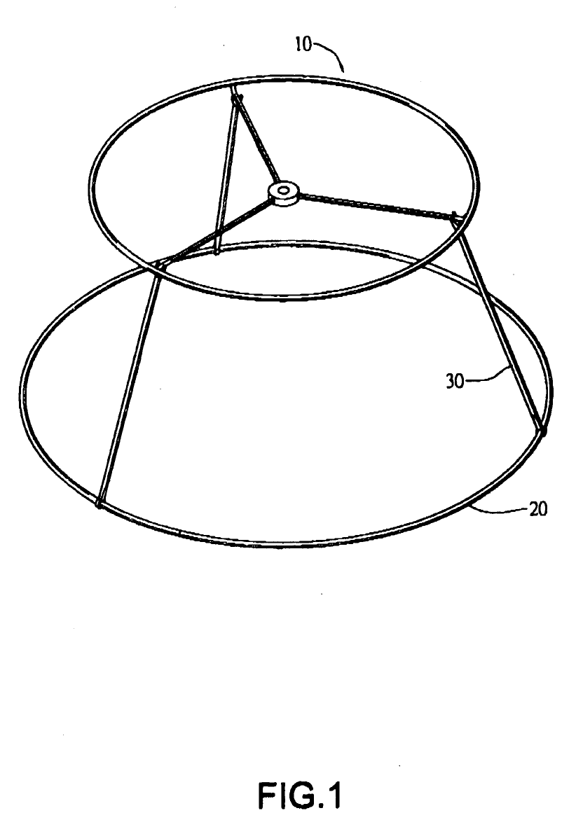

With reference to FIG. 1, a collapsible lampshade frame in accordance with the present invention comprises #n upper ring (10), a lower ring (20) and multiple ribs (30).

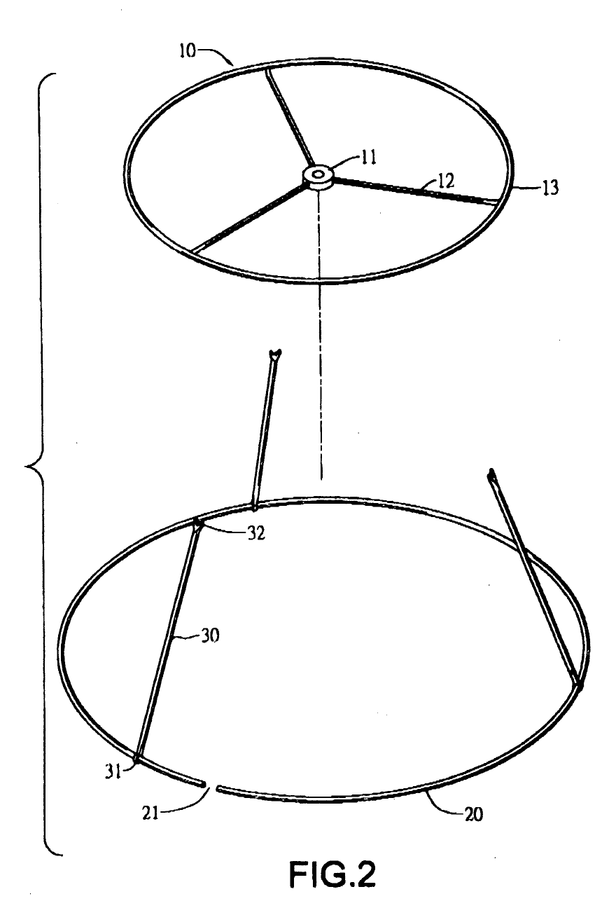

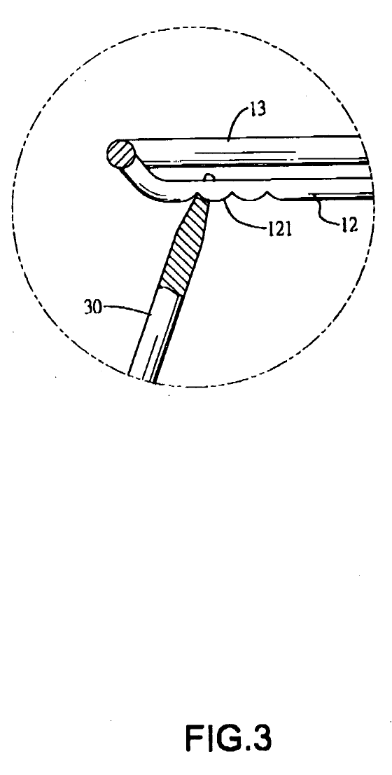

With further reference to FIGS. 2 and 3, the upper ring (10) has a central mounting bracket (11), multiple radial supports (12) and an outer ring (13). The multiple radial supports (12) connect to and extend out radially from the central mounting bracket (11), and each radial support (12) has a top, a bottom and multiple wavy recesses (121). The wavy recesses (121) are formed on the bottom of the radial support (12). The outer ring (13) is connected to the multiple radial supports (12). The wavy recesses (121) are formed optionally near the outer ring (13).

The lower ring (20) has a split (21).

The ribs (30) are attached to the lower ring (20), and each rib (30) has a proximal end, a distal end, a through hole (31) and a fork (32). The through hole (31) is formed in the proximal end of the rib (30), and the lower ring (20) passes through the through hole (31) at the split (21) in the lower ring (20) to mount the ribs (30) pivotally on lower ring (20). The fork (32) is formed in the distal end of the rib (30) and engages the wavy recesses (121) on the radial support (12). Using three ribs (30) is a preferred option because requires the smallest amount of material to get a stable condition. Nevertheless, using more than three ribs is still practical.

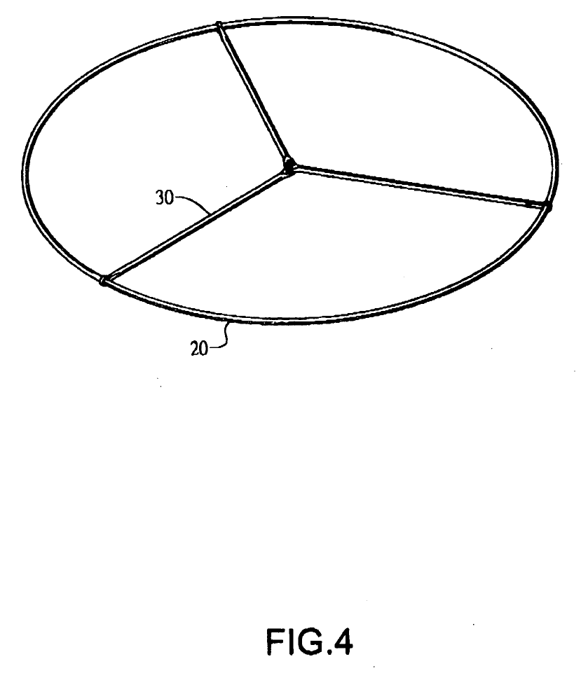

With further reference to FIG. 4, the frame is collapsed by disengaging the forks (32) in the ribs (30) from the wavy recesses (121) on the radial supports (12) of the upper ring (10). Then the ribs (30) are pivoted inward on the lower ring (20) to reduce the volume of the frame. Therefore when the frame for the lamp is moved or stored, the frame can be collapsed and will not occupy excessive space.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A collapsible lampshade frame comprising
an upper ring having
a central mounting bracket;
multiple radial supports connecting to and extending out radially from the central mounting bracket, and each radial support having
a top;
a bottom; and
multiple wavy recesses formed on the bottom of the radial support; and
an outer ring connected to the multiple radial supports;
a lower ring having a split; and
multiple ribs pivotally attached to the lower ring and detachably connected to the upper ring, and each rib having
a proximal end;
a distal end:
a through hole formed in the proximal end of the rib wherein the lower ring posses through the through hole at the split in the lower ring to mount the ribs pivotally on the lower ring; and
a fork formed in the distal end of the rib and engaging the wavy recesses on the radial support.

2. The frame as claimed in claim 1, wherein the wavy recesses are formed near the outer ring.
